(19) United States
(12) Patent Application Publication
(10) Pub. No.: US 2018/0013678 A1
(43) Pub. Date: Jan. 11, 2018

(54) CONNECTION DESTINATION DETERMINATION METHOD AND INFORMATION PROCESSING DEVICE

(71) Applicant: FUJITSU LIMITED, Kawasaki-shi (JP)

(72) Inventor: Susumu KOGA, Kawasaki (JP)

(73) Assignee: FUJITSU LIMITED, Kawasaki-shi (JP)

(21) Appl. No.: 15/498,949

(22) Filed: Apr. 27, 2017

(30) Foreign Application Priority Data
Jul. 6, 2016 (JP) 2016-134521

(51) Int. Cl. H04L 12/803; H04L 29/08

(52) U.S. Cl. CPC H04L 47/125; H04L 67/141

(57) ABSTRACT

A method is executed by a computer which communicates with a plurality of terminal devices and a plurality of servers. The method includes receiving a request for assignment of a server from a first terminal device, identifying a first group to which the first terminal device belongs based on group information managing groups to which the plurality of terminal devices belong respectively, determining whether another terminal device belonging to the first group is coupled to any one of the plurality of servers based on the group information and connection information indicating a connection relationship between the plurality of servers and at least one of the plurality of terminal devices, and when the other terminal device is coupled to any one of the plurality of servers, assigning a first server coupled to the other terminal device to the first terminal device.

### CROSS-REFERENCE TO RELATED APPLICATION

This application is based upon and claims the benefit of priority of the prior Japanese Patent Application No. 2016-134521, filed on Jul. 6, 2016, the entire contents of which are incorporated herein by reference.

### FIELD

The embodiments discussed herein are related to a technique for determining a connection destination.

### BACKGROUND

Users of supporter terminals often remotely support supportee terminals by coupling the supporter terminals with the supportee terminals. In order to couple the supporter terminals and the supportee terminals in a many-to-many relationship, a server that relays the supporter terminals and the supportee terminals is used. When the number of supporter terminals and the number of supportee terminals that participate in remote support increase, it becomes difficult to perform connection management by one server. In such a case, a method, such as “scale up” that improves the performance of a server, “scale out” that increases the number of servers, and the like are performed. When the scaling out of a server is carried out, a load balancer performs load distribution, such as determination of a server to be coupled in accordance with the load state of each server, or the like.

Related-art techniques are disclosed in, for example, International Publication Pamphlet No. WO 2010/110155 and Japanese Laid-open Patent Publication Nos. 2003-18302 and 2012-38152.

### SUMMARY

According to an aspect of the invention, a method is executed by a computer which communicates with a plurality of terminal devices and a plurality of servers. The method includes receiving a request for assignment of a server, among the plurality of servers, from a first terminal device among the plurality of terminal devices, identifying a first group to which the first terminal device belongs based on group information managing groups to which the plurality of terminal devices belong respectively, determining whether another terminal device belonging to the first group is coupled to any one of the plurality of servers based on the group information and connection information indicating a connection relationship between the plurality of servers and at least one of the plurality of terminal devices, when the other terminal device is coupled to any one of the plurality of servers, assigning a first server coupled to the other terminal device to the first terminal device, and when the other terminal device is not coupled to any one of the plurality of servers, assigning a second server to the first terminal device, the second server being selected based on load information indicating respective loads of the plurality of servers.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a remote support system according to an embodiment;

FIG. 2 is a block diagram illustrating an example of a configuration of a load balancer according to the embodiment;

FIG. 3 is a diagram illustrating an example of a terminal group storage unit;

FIG. 4 is a diagram illustrating an example of a connection server storage unit;

FIG. 5 is a diagram illustrating an example of a load information storage unit;

FIG. 6 is a diagram illustrating an example of a connection between a terminal and servers;

FIG. 7 is a flowchart illustrating an example of connection destination determination processing according to the embodiment; and

FIG. 8 is a diagram illustrating an example of a computer that performs the connection destination determination program.

### DESCRIPTION OF EMBODIMENTS

For example, in order for a plurality of supporter terminals to perform remote support to a plurality of supportee terminals at the same work site, if a terminal group including individual terminals is formed, a supporter terminal and a supportee terminal that belong to the same terminal group sometimes are coupled to different servers respectively. For example, when two terminals that belong to a certain terminal group are already coupled via a server, and the load of the server is high, if another supportee terminal that belongs to the same terminal group newly attempts to couple to the supporter terminal, that supportee terminal sometimes is coupled to another server. Accordingly, for example, although the two terminals belong to the same terminal group, the terminals might be coupled to different servers, that is to say, information processing devices respectively, and thus the supportee terminal sometimes fails to be coupled to the supporter terminal.

According to an aspect of the present disclosure, it is desirable to realize a connection to the same information processing device for each terminal group by the technique disclosed in the embodiments.

In the following, detailed descriptions will be given of a connection destination determination program, a connection destination determination method, and an information processing device according to the embodiments of the present disclosure with reference to the drawings. In this regard, the disclosed technique is not limited by the embodiments. Also, the following embodiments may be suitably combined within a range that does not cause a contradiction.

### EMBODIMENTS

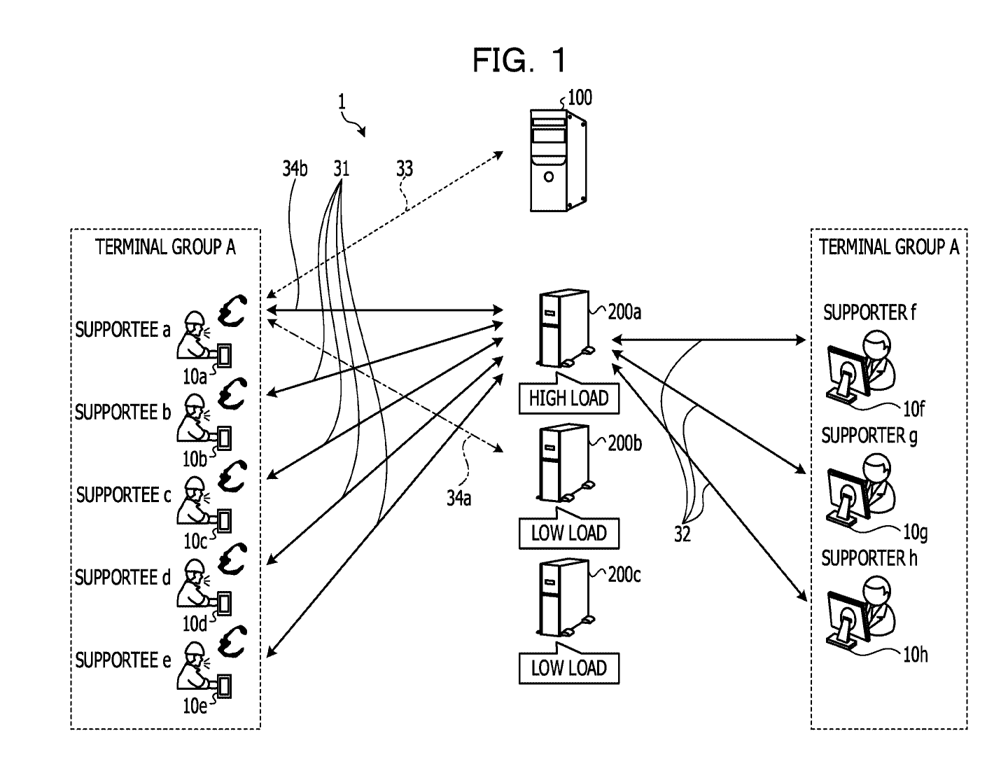

FIG. 1 is a diagram illustrating an example of a configuration of a remote support system according to an embodiment. A remote support system 1 illustrated in FIG. 1 is a remote support system that couples supporter terminals and supportee terminals in a many-to-many relationship, and includes supportee terminals 10a to 10e, supporter terminals 10f to 10h, a load balancer 100, and servers 200a to 200c. The supportee terminals 10a to 10e, the supporter terminals 10f to 10h, the load balancer 100, and the servers 200a to 200c are mutually coupled in a communicable manner via a network not illustrated in FIG. 1. Also, the supportee terminals 10a to 10e and the supporter terminals 10f to 10h belong to the same terminal group A.

In this regard, in the following description, in the case where the supportee terminals 10a to 10e and the supporter terminals 10f to 10h are not distinguished, the terminals are sometimes referred to as a terminal 10. Also, when supporters and supportees are not distinguished, they are sometimes referred to as a user. Further, if the servers 200a to 200c are not distinguished, they are sometimes referred to as a server 200.

The supportee terminals 10a to 10e are terminals used, for example, by workers at a work site. The supportee terminals 10a to 10e are information processing devices that are worn by the workers and it is possible to use mobile communication terminals, for example, tablet terminals, smartphones, or the like for the supportee terminals 10a to 10e. Also, it may be possible to couple head mounted displays (HMDs) to the supportee terminals 10a to 10e. In this regard, it is assumed that the supportee terminals 10a to 10e are used by supportees a to e, who are workers respectively.

The supporter terminals 10f to 10h are terminals that are used by the supporters, for example, who issue instructions to the workers at the work site and perform remote operation of the supportee terminals 10a to 10e. As an example of the supporter terminals 10f to 10h, it is possible to use a desktop personal computer. For the supporter terminals 10f to 10h, it is possible to employ mobile communication terminals, for example, portable personal computers, smartphones, mobile phones, or the like in addition to the desktop personal computer described above. In this regard, the supporter terminals 10f to 10h are used by supporters f to h respectively.

The load balancer 100 performs load distribution of the servers 200a to 200c that relay communication between the supportee terminals 10a to 10e and the supporter terminals 10f to 10h. The load balancer 100 determines a server 200 that relays communication based on a connection request from a terminal 10. In this regard, the load balancer 100 is an example of an information processing device that executes a connection destination determination program, that is to say, a computer.

The server 200 relays communication between the supportee terminals 10a to 10e and the supporter terminals 10f to 10h. The server 200 receives an instruction regarding the terminal 10 from which the relay communication is to be relayed from the load balancer 100. The server 200 that has been determined to relay the communication by the load balancer 100 relays the communication between the terminal 10 of the connection request source and the terminal 10 of the connection request destination based on the connection request from the terminal 10. Also, when the server 200 receives the connection state of the terminal 10 and an acquisition request of the load information of the server 200 from the load balancer 100, the server 200 transmits the connection state of the terminal 10 and the load information of the server 200 to the load balancer 100. In this regard, the server 200 is an example of the information processing device to which the terminal 10 is coupled.

Next, with reference to FIG. 1, a description will be given of the case where a supportee terminal 10a that belongs to a terminal group A makes a new connection request when the supportee terminals 10b to 10e that belong to the terminal group A and the supporter terminals 10f to 10h are coupled via the server 200a. In the example in FIG. 1, the supportee terminals 10b to 10e and the server 200a are coupled by a connection 31 respectively. Also, the server 200a and the supporter terminals 10f to 10h are coupled by a connection 32 respectively. Further, it is assumed that the server 200a relays the communication between the supportee terminals 10b to 10e and the supporter terminals 10f to 10h, and thus the server 200a has a high load. Also, it is assumed that the servers 200b and 200c have a low load.

First, the supportee terminal 10a transmits to the load balancer 100 a connection request 33 to a connection destination server. The load balancer 100 acquires the connection state of the terminal 10 and the load information of the server from the servers 200a to 200c. Since the server 200a has a high load, with the related-art load distribution, the load balancer 100 establishes, for example, a connection 34a to the server 200b having a low load. However, the supportee terminal 10a belongs to the same terminal group A with the supportee terminals 10b to 10e and the supporter terminals 10f to 10h that are coupled to the server 200a, and thus establishes a connection 34b with the server 200a.

That is to say, the load balancer 100 includes a terminal group storage unit that stores the identification information of the plurality of terminals 10 included in a terminal group in association with the terminal group. Also, the load balancer 100 includes a connection server storage unit that stores the identification information of the terminal 10 coupled to the information processing device that is the server 200 in association with the information processing device. When the load balancer 100 receives the identification information of the terminal of the connection request source, the load balancer 100 refers to the terminal group storage unit and the connection server storage unit, and determines whether or not another terminal 10 included in the same terminal group as that of the terminal 10 of the received connection request source is coupled to any one of the information processing devices. If the other terminal 10 is not coupled to any one of the information processing devices, the load balancer 100 transmits the identification information of the information processing device selected from the plurality of information processing devices to the terminal 10 of the connection request source based on the load information of the plurality of information processing devices that are connection candidates. Also, if the other terminal 10 is coupled to any one of the information processing devices, the load balancer 100 transmits the identification information of the one of the information processing device to the terminal 10 of the connection request source. Thereby, it is possible for the load balancer 100 to realize a connection to the same information processing device for each terminal group.

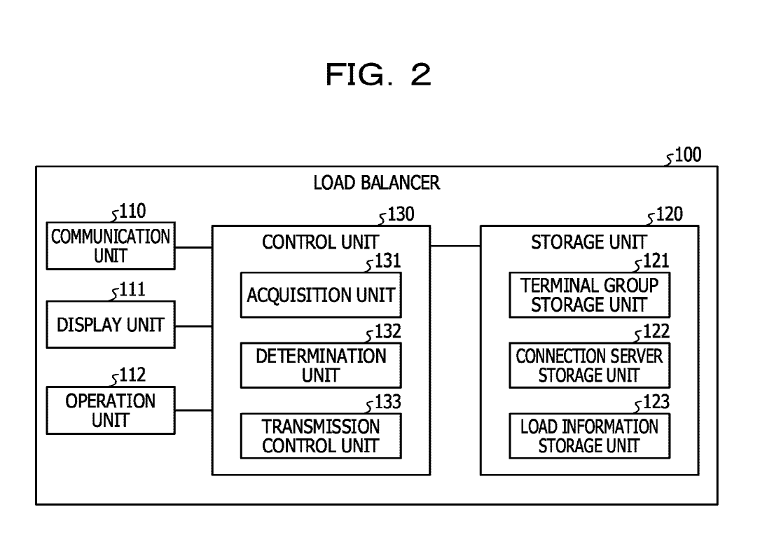

Next, a description will be given of the configuration of the load balancer 100 with reference to FIG. 2. FIG. 2 is a diagram illustrating an example of the configuration of the load balancer according to the embodiment. As illustrated in FIG. 2, the load balancer 100 includes a communication unit 110, a display unit 111, an operation unit 112, a storage unit 120, and a control unit 130. In this regard, the load balancer 100 may include various functional units possessed by known computers, for example, various input devices, audio output devices, and the like in addition to the functional units illustrated in FIG. 2.

The communication unit 110 is realized, for example, by a network interface card (NIC), or the like. The communication unit 110 is a communication interface that is coupled wiredly or wirelessly to each terminal 10 and each server 200 via a network not illustrated in FIG. 2, and controls communication of the information between each terminal 10 and each server 200. The communication unit 110 receives a connection request from each terminal 10. Also, the communication unit 110 receives the connection state of the terminal 10 from each server 200 and the load information of the server 200. The communication unit 110 outputs the received connection request, the connection state of the terminal 10, and the load information of the server 200 to the control unit 130. Also, the communication unit 110 transmits the identification information of the server 200 indicating the connection destination, which was input from the control unit 130 to the terminal 10 of the connection request source. Further, the communication unit 110 transmits the acquisition request of the connection state of the terminal 10 and the load information of the server 200, which was input from control unit 130 to each server 200.

The display unit 111 is a display device for displaying various kinds of information. The display unit 111 is realized, for example, by a liquid crystal display, or the like as a display device. The display unit 111 displays various screens, such as a display screen that was input from the control unit 130, or the like.

The operation unit 112 is an input device that receives various operations from an administrator of the remote support system 1. The operation unit 112 is realized, for example, by a keyboard, a mouse, or the like as an input device. The operation unit 112 outputs the operation input by the administrator to the control unit 130 as operation information. In this regard, the operation unit 112 may be realized by a touch panel, or the like as the input device, and the display device of the display unit 111 and the input device of the operation unit 112 may be integrated.

The storage unit 120 is realized by a semiconductor memory element, for example, a random access memory (RAM), a flash memory, or the like, or a storage device, such as a hard disk, an optical disc, or the like. The storage unit 120 includes a terminal group storage unit 121, a connection server storage unit 122, and a load information storage unit 123. Also, the storage unit 120 stores the information used for the processing by the control unit 130.

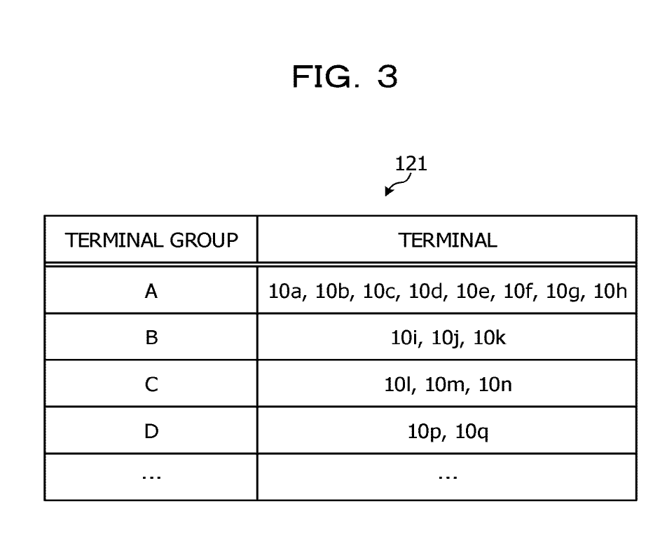

The terminal group storage unit 121 stores the identification information of a plurality of terminals 10 included in a terminal group in association with the terminal group. FIG. 3 is a diagram illustrating an example of the terminal group storage unit. As illustrated in FIG. 3, the terminal group storage unit 121 includes items, such as “terminal group” and “terminal”. The terminal group storage unit 121 stores, for example, one record for each terminal group.

The item “terminal group” is an identifier that identifies a terminal group. The item “terminal” is the identification information of terminals that belong to the terminal group. In the example in the first row in FIG. 3, the terminals “10a, 10b, 10c, 10d, 10e, 10f, 10g, and 10h” belong to a terminal group “A”.

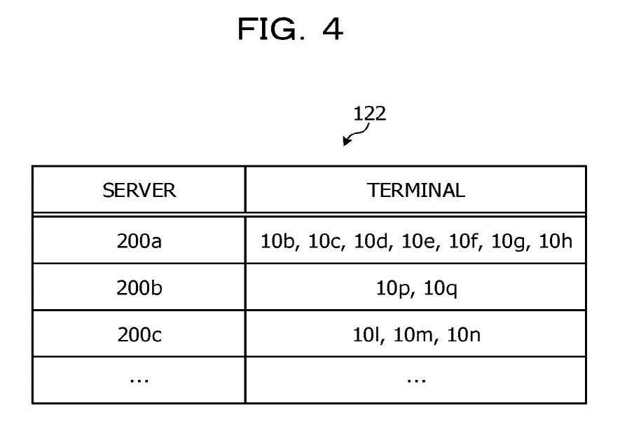

Referring back to FIG. 2, the connection server storage unit 122 stores the identification information of terminals 10 coupled to each server 200 in association with each server 200. FIG. 4 is a diagram illustrating an example of the connection server storage unit. As illustrated in FIG. 4, the connection server storage unit 122 includes items, such as “server” and “terminal”. The connection server storage unit 122 sores, for example, one record for each server 200.

The item “server” is an identifier that identifies a server 200. The item “terminal” is the identification information of the terminals coupled to the corresponding server 200 among the terminals that belong to a terminal group. In the example in the first row in FIG. 4, the terminals “10b, 10c, 10d, 10e, 10f, 10g, and 10h” are coupled to the server “200a”. That is to say, by referring to FIG. 3, it is understood that the terminals 10 that belong to the terminal group “A” are coupled to the server “200a”. In the same manner, by referring to FIG. 3, it is understood that in the example in the second row in FIG. 4, terminals “10p and 10q” that belong to the terminal group “D” are coupled to the server “200b”.

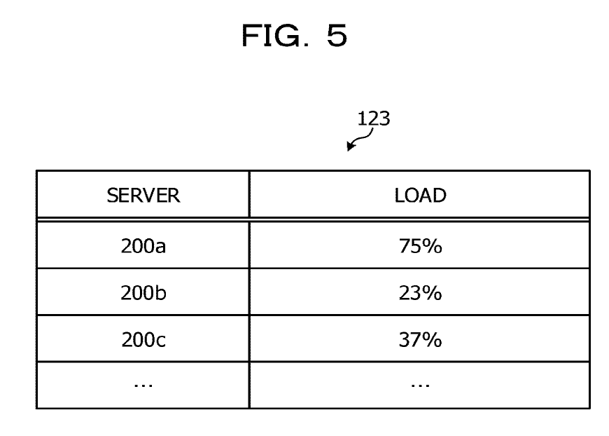

Referring back to FIG. 2, the load information storage unit 123 stores load information of each server 200. FIG. 5 is a diagram illustrating an example of the load information storage unit. As illustrated in FIG. 5, the load information storage unit 123 includes items “server” and “load”. The load information storage unit 123 stores, for example, one record for each server 200.

The item “server” is an identifier that identified a server 200. The item “load” is the amount of load based on the load information of the server, which was acquired from each server 200. The item “load” is calculated, for example, based on the data traffic of the terminal group that is coupled to the server 200 and the number of terminals 10 that are coupled, or the like.

Referring back to FIG. 2, the control unit 130 is realized, for example, by a central processing unit (CPU), a micro processing unit (MPU), or the like executing a program stored in the internal storage device using a RAM as a work area. Also, the control unit 130 may be realized, for example, by an integrated circuit, such as an application specific integrated circuit (ASIC), a field programmable gate array (FPGA), or the like. The control unit 130 includes an acquisition unit 131, a determination unit 132, and a transmission control unit 133, and performs the functions and the operation of the information processing described below. In this regard, the internal configuration of the control unit 130 is not limited to the configuration illustrated in FIG. 2, and may be another configuration as long as the configuration in which the information processing described below is performed.

The acquisition unit 131 determines whether or not a connection request has been received from the terminal 10 of the connection request source via the communication unit 110. That is to say, the acquisition unit 131 determines whether or not a connection request has been received from the terminal 10 of the connection request source. If the acquisition unit 131 has received a connection request, the acquisition unit 131 transmits an acquisition request of the connection state of the terminal 10 and the load information of the server 200 to each server 200 via the communication unit 110.

The acquisition unit 131 receives and acquires the connection state of the terminal 10 corresponding to the acquisition request from each server 200 and the load information of the server 200 via the communication unit 110. The acquisition unit 131 stores the connection state of the terminal 10 and the load information of the server 200 that were acquired in the connection server storage unit 122 and the load information storage unit 123 respectively. When the acquisition unit 131 stores the connection state of the terminal 10 and the load information of the server 200 in the connection server storage unit 122 and the load information storage unit 123 respectively, the acquisition unit 131 outputs a determination instruction to the determination unit 132.

When the determination unit 132 receives input of the determination instruction from the acquisition unit 131, the determination unit 132 refers to

the terminal group storage unit 121 and the connection server storage unit 122 and determines whether or not the other terminal 10 of the terminal group to which the terminal 10 of the connection request source belongs is coupled to any one of the servers 200. If the other terminal 10 is coupled to any one of the servers 200, the determination unit 132 outputs a determination result stating that the other terminal 10 is coupled to the transmission control unit 133. If the other terminal 10 is not coupled to any one of the servers 200, the determination unit 132 outputs, to the transmission control unit 133, a determination result stating that the other terminal 10 is not coupled to the transmission control unit 133.

If the transmission control unit 133 receives input of the determination result stating that the other terminal 10 is coupled from the determination unit 132, the transmission control unit 133 acquires the identification information of the coupled server 200 from the connection server storage unit 122. The transmission control unit 133 transmits the acquired identification information of the coupled server 200 to the terminal 10 of the connection request source via the communication unit 110 as the identification information of the server 200 indicating the connection destination.

When the transmission control unit 133 receives input of the determination result stating that the other terminal 10 is not coupled from the determination unit 132, the transmission control unit 133 refers to the load information storage unit 123, and selects the server 200 to be coupled based on the load information of the connection candidate server 200. The transmission control unit 133 transmits the identification information of the selected server 200 to the terminal 10 of the connection request source via the communication unit 110 as the identification information of the server 200 indicating the connection destination.

In this regard, the transmission control unit 133 may select a server 200 to be coupled based on the number of the other terminals 10 that belong to the same group as the terminal 10 of the connection request source as the load information. That is to say, if a certain terminal 10 belongs to a plurality of terminal groups, the transmission control unit 133 has to couple the other terminals 10 of each terminal group to the same server 200 as that terminal 10 in the future, and thus the transmission control unit 133 uses the number of the other terminals 10 as the load information.

Also, the load information may be the information, such as the data traffic of the other terminal group on the server 200 and the information regarding the number of coupled terminals 10 in the case where a terminal 10 included in the other terminal group is coupled to the server 200. That is to say, in the remote support system 1, when the function of the data communication processing, such as voice communication, video sharing, or the like is used, a load arises between the terminal 10 and the server 200. Accordingly, the transmission control unit 133 calculates the load information based on the use state of the functions of voice communication in each terminal group, video sharing, and the like, and the number of terminals 10 that are involved, that is to say, that are coupled in each terminal group.

Further, if a terminal 10 of the connection request source belongs to a plurality of terminal groups, the transmission control unit 133 may select a server 200 to be coupled based on the number of terminal groups in which the terminal 10 of the connection request source is included as the load information. That is to say, in the case where the number of terminal groups in which a certain terminal 10 is involved is large, even if the current number of terminals 10 coupled to the server 200 is small, the transmission control unit 133 determines that there is a possibility that the terminal 10 that belongs to a large number of terminal groups is coupled to the server 200 and uses various functions. Accordingly, the transmission control unit 133 predicts the amount of increased load of the server 200 in the future based on the number of terminal groups to which a certain terminal 10 is involved.

Also, the transmission control unit 133 determines, for example, whether or not the administrator of the remote support system 1 has input an end instruction to terminate the remote support system 1. That is to say, the transmission control unit 133 determines whether or not to terminate the remote support system 1. When the transmission control unit 133 does not terminate the remote support system 1, the transmission control unit 133 waits for a connection request from a terminal 10. When the transmission control unit 133 terminates the remote support system 1, the transmission control unit 133 instructs each unit to terminate the connection destination determination processing.

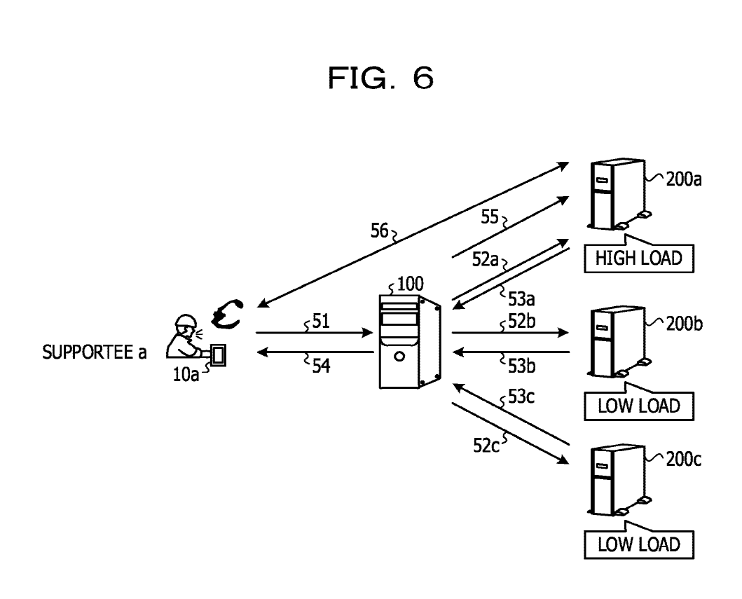

Here, a description will be given of a connection between the terminal 10 and the server 200 with reference to FIG. 6. FIG. 6 is a diagram illustrating an example of a connection between a terminal and servers. In this regard, in the example in FIG. 6, it is assumed that the other terminal 10 in the terminal group to which a supportee terminal 10a of a supportee a belongs is coupled to the server 200a, and the server 200a is in a high load state.

As illustrated in FIG. 6, first, the supportee terminal 10a of the supportee a who attempts to establish a new connection transmits a connection request 51 to the load balancer 100. The load balancer 100 transmits acquisition requests 52a, 52b, and 52c of the connection state of the other terminals 10 of the terminal group to which the supportee terminal 10a belongs and the load information to the servers 200a, 200b, and 200c, respectively.

The load balancer 100 receives the connection state of the terminal 10 and the load information 53a, 53b, and 53c from the servers 200a, 200b, and 200c, respectively. The load balancer 100 individually stores the received connection state of the terminal 10 and load information 53a, 53b, and 53c in the connection server storage unit 122 and the load information storage unit 123.

The load balancer 100 refers to the terminal group storage unit 121 and the connection server storage unit 122, and determines whether or not the other terminal 10 of the terminal group to which the supportee terminal 10a belongs is coupled to any one of the servers 200. The load balancer 100 determines that the other terminal 10 is coupled to the server 200a in accordance with the above-described condition. The load balancer 100 transmits the identification information 54 of the server 200a to the supportee terminal 10a as the connection destination of the supportee terminal 10a. Also, the load balancer 100 transmits an instruction 55 to the server 200a so that the server 200a receives a connection from the supportee terminal 10a.

When the supportee terminal 10a receives the identification information 54 of the server 200a from the load balancer 100, the supportee terminal 10a requests a connection to the server 200a, and establishes a connection 56 so as to start communication with the server 200a. In this manner, even if the server 200a is in a high load state, the terminal 10 that belongs to the same terminal group as the supportee terminal 10a is already connected, and thus the load balancer 100 couples the supportee terminal 10a to the server 200a. Thereby, it is possible for the supportee a who uses the supportee terminal 10a to communicate with the supporter who belongs to the same terminal group.

That is to say, the load balancer 100 integrates each server's 200 management functions of the terminal group and the terminal 10 (user) so as distribute the servers 200 to which the terminals 10 are coupled. That is to say, the load balancer 100 adds the management state of the terminal group and the terminal 10 to the elements of the load distribution processing in addition to the determination of a connection destination by the simple load state of the server, the number of connections, and the processing performance in the same manner as the related-art load balancer. In this regard, the management information of the terminal group and the terminal 10 is collectively managed by the load balancer 100, and the information is transmitted from the load balancer 100 to the server 200 in sequence at the timing when the terminal 10 makes a connection request.

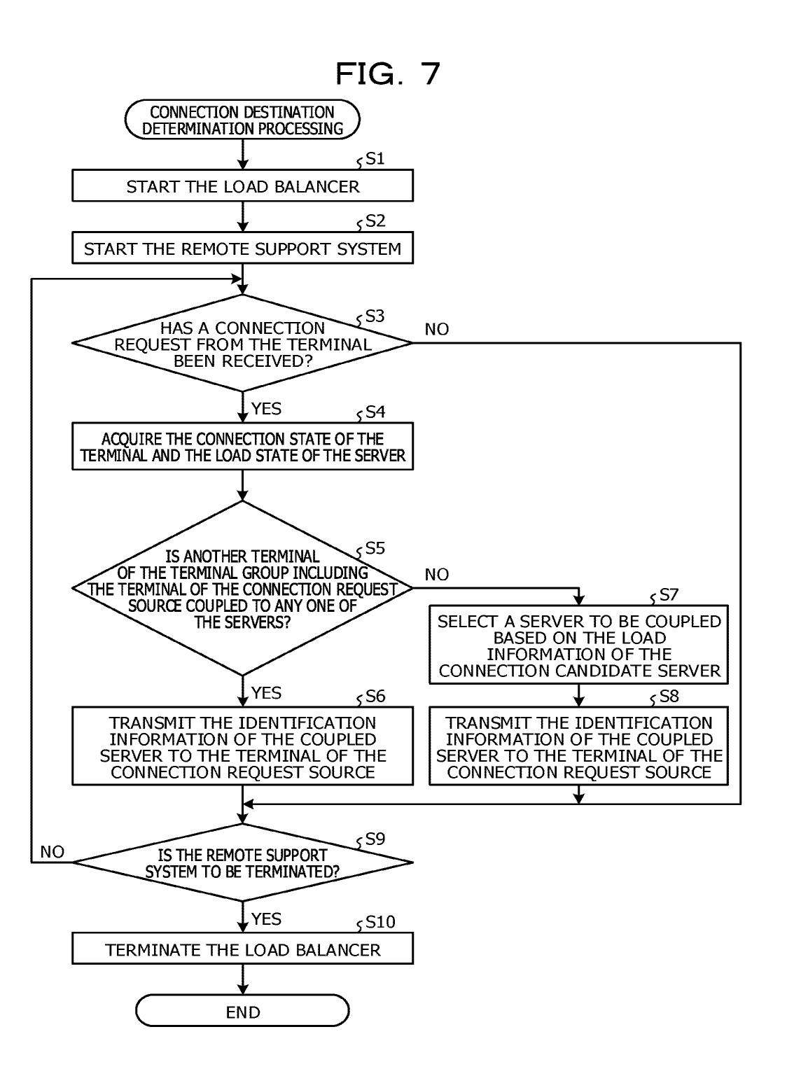

Next, a description will be given of the operation of the remote support system 1 according to the embodiment. FIG. 7 is a flowchart illustrating an example of the connection destination determination processing according to the embodiment.

The administrator of the remote support system 1 starts the load balancer 100 (step S1). Next, the load balancer 100 starts the remote support system 1 with each server 200 (step S2).

The acquisition unit 131 of the load balancer 100 determines whether or not the acquisition unit 131 has received a connection request from the terminal 10 of the connection request source (step S3). If the acquisition unit 131 has not received a connection request from the terminal 10 (step S3: negation), the processing proceeds to step S9. If the acquisition unit 131 has received a connection request from the terminal 10 (step S3: affirmation), the acquisition unit 131 transmits an acquisition request of the connection state of the terminal 10 and the load information of the server 200 to each server 200.

When each server 200 receives the acquisition request of the connection state of the terminal 10 and the load information of the server 200 from the load balancer 100, each server 200 transmits the connection state of the terminal 10 and the load information of the server 200 to the load balancer 100.

The acquisition unit 131 of the load balancer 100 receives and acquires the connection state of the terminal 10 and the load information of the server 200 in response to the acquisition request from each server 200 (step S4). The acquisition unit 131 stores the acquired connection state of the terminal 10 and the load information of the server 200 in the connection server storage unit 122 and the load information storage unit 123 respectively, and outputs a determination instruction to the determination unit 132.

When the determination unit 132 receives input of the determination instruction from the acquisition unit 131, the determination unit 132 determines whether or not the other terminal 10 of the terminal group to which the terminal 10 of the connection request source belongs is coupled to any one of the servers 200 (step S5). If the other terminal 10 is coupled to any one of the servers 200 (step S5: affirmation), the determination unit 132 outputs a determination result stating “coupled” to the transmission control unit 133. When the transmission control unit 133 receives input of the determination result stating that the other terminal 10 is coupled from the determination unit 132, the determination unit 132 transmits the identification information of the coupled server 200 to the terminal 10 of the connection request source (step S6). The terminal 10 of the connection request source is coupled to the server 200 and starts communication based on the received identification information of the server 200.

If the other terminal 10 is not coupled to any one of the servers 200 (step S5: negation), the determination unit 132 outputs a determination result stating “not coupled” to the transmission control unit 133. When the transmission control unit 133 receives input of a determination result stating “not coupled” from the determination unit 132, the transmission control unit 133 selects a server 200 to be coupled based on the load information of the connection candidate server 200 (step S7). The transmission control unit 133 transmits the identification information of the selected server 200 to the terminal 10 of the connection request source (step S8). The terminal 10 of the connection request source is coupled to the server 200 based on the identification information of the received server 200, and starts communication.

The transmission control unit 133 of the load balancer 100 determines whether or not to terminate the remote support system 1 (step S9). If the transmission control unit 133 does not terminate the remote support system 1 (step S9: negation), the processing returns to step S3. If the transmission control unit 133 terminates the remote support system 1 (step S9: affirmation), the transmission control unit 133 instructs each unit to terminate the connection destination determination processing. The load balancer 100 is terminated by the administrator of the remote support system 1 (step S10). Thereby, it is possible for the load balancer 100 to realize connections to the same server 200 for each terminal group.

In this manner, the load balancer 100 includes the terminal group storage unit 121 that stores the identification information of a plurality of terminals 10 included in a terminal group in association with the terminal group. Also, the load balancer 100 includes the connection server storage unit 122 that stores the identification information of a terminal 10 coupled to the information processing device, which is the server 200, in association with the information processing device. Also, when the load balancer 100 receives the identification information of the terminal 10 of the connection request source, the load balancer 100 refers to the terminal group storage unit 121 and the connection server storage unit 122, and determines whether or not the other terminal 10 included in the same terminal group as that of the terminal 10 of received connection request source is coupled to any one of the information processing devices. Also, if the other terminal 10 is not coupled to any one of the information processing devices, the load balancer 100 transmits the identification information of the information processing device selected from a plurality of information processing devices based on the load information of a plurality of information processing devices that are connection candidates to the terminal 10 of the connection request source. Also, if the other terminal 10 is coupled to any one of the information processing devices, the load balancer 100 transmits the identification information of the one of information processing devices to the terminal 10 of the connection request source. As a result, it is possible to realize a connection to the same information processing device for each terminal group.

Also, if the other terminal 10 is not coupled to any one of the information processing devices, the load balancer 100 transmits the identification information of the information processing device selected from a plurality of information processing devices based on the number of other terminals 10 to the terminal 10 of connection request source. As a result, it is possible to realize a connection to the same information processing device for each terminal group in consideration of the load of the terminal 10 having a possibility of connection in the future.

Also, in the load balancer 100, the load information is the information regarding the data traffic of the other terminal group in the information processing device, and the number of connected terminals 10 when the terminal included in the other terminal group is coupled to the information processing device. As a result, it is possible to calculate the load information based on the data traffic in each terminal group and the number of connected terminals 10.

Also, if the other terminal 10 is not coupled to any one of the information processing devices, the load balancer 100 transmits the identification information of the information processing device selected from a plurality of information processing devices based on the number of terminal groups in which the terminal 10 of the connection request source is included to the terminal 10 of the connection request source. As a result, it is possible to predict the amount of increased load of the information processing device in the future and determine the connection destination of the terminal 10 based on the number of terminal groups in which the terminal 10 is involved.

In this regard, in the above-described embodiment, a description has been given of the case where each terminal 10 of the terminal group A is coupled to the server 200a, but the present disclosure is not limited to this. For example, even if the server 200a has a low load when each terminal 10 of the terminal group A is coupled, a plurality of terminal groups including the other terminal group may be coupled to the server 200a.

Also, each component of each unit illustrated in the diagrams does not have to be physically configured as illustrated. That is to say, a specific form of distribution and integration of each unit is not limited to the one illustrated in the diagrams, and it is possible to functionally or physically distribute or integrate all of or a part of the unit in any units in accordance with the various loads, use state, or the like. For example, the acquisition unit 131 and the determination unit 132 may be integrated. Also, each processing illustrated in the diagrams is not limited to be performed in the above-described order. Each processing may be performed at the same time, or the order of execution may be replaced as long as a contradiction does not arise in the processing contents.

Further, all of or any one of the various processing functions performed by each device may be executed by a CPU (or a microcomputer, such as an MPU, a micro controller unit (MCU), or the like). Also, all of or any one of the various processing functions may performed by a program analyzed and executed by a CPU (or a microcomputer, such as an MPU, an MCU, or the like), or hardware by a wired logic as a matter of course.

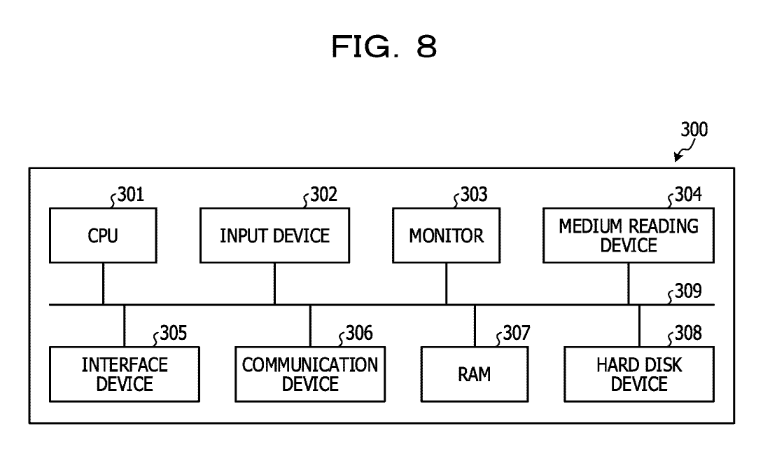

Incidentally, it is possible to realize the various kinds of processing described in the above-described embodiment by a computer executing a program provided in advance. Thus, in the following, a description will be given of an example of the computer that executes the program having the same functions as those of the embodiment described above. FIG. 8 is a diagram illustrating an example of a computer that performs the connection destination determination program.

As illustrated in FIG. 8, a computer 300 includes a CPU 301 that executes various kinds of operation processing, an input device 302 that receives data input, and a monitor 303. Also, the computer 300 includes a medium reading device 304 that reads a program, or the like from a storage medium, an interface device 305 for coupling to various devices, and a communication device 306 that wiredly or wirelessly couples to the other information processing devices, or the like. Also, the computer 300 includes a RAM 307 that temporarily stores various kinds of information and a hard disk device 308. Also, individual devices 301 to 308 are coupled to a bus 309.

The hard disk device 308 stores a connection destination determination program that has the same functions as those of each processing unit of the acquisition unit 131, the determination unit 132, and the transmission control unit 133 that are illustrated in FIG. 2. Also, the hard disk device 308 stores the terminal group storage unit 121, the connection server storage unit 122, the load information storage unit 123, and various kinds of data for realizing the connection destination determination program. The input device 302 has the same function as that of the operation unit 112 illustrated in FIG. 2, for example, and receives input of the various kinds of information, such as the operation information, or the like from the administrator of the computer 300. The monitor 303 displays, for example, various screens, such as a display screen, or the like to the administrator of the computer 300. For example, a printer, or the like is coupled to the interface device 305. The communication device 306 has, for example, the same function as the communication unit 110 illustrated in FIG. 2, is coupled to the terminal 10 and the server 200, and exchanges various kinds of information with the terminal 10 and the server 200.

The CPU 301 reads each program stored in the hard disk device 308 and loads the program in the RAM 307 so as to perform various kinds of processing. Also, it is possible for each of these programs to cause the computer 300 to function as the acquisition unit 131, the determination unit 132, and the transmission control unit 133 that are illustrated in FIG. 2.

In this regard, the connection destination determination program described above does not have to be stored in the hard disk device 308. For example, the computer 300 may read the program stored in a storage medium from which the computer 300 is capable of reading. The storage medium from which the computer 300 is capable of reading corresponds to, for example, a portable recording medium, such as a CD-ROM, a DVD disc, a Universal Serial Bus (USB) memory, or the like, a semiconductor memory, such as a flash memory, or the like, a hard disk drive or the like. Also, the connection destination determination program may be stored in a device that is coupled to a public line, the Internet, a LAN, or the like, and the connection destination determination program may be read and executed by the computer 300.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method executed by a computer which communicates with a plurality of terminal devices and a plurality of servers, the method comprising:
receiving a request for assignment of a server, among the plurality of servers, from a first terminal device among the plurality of terminal devices;
identifying a first group to which the first terminal device belongs based on group information managing groups to which the plurality of terminal devices belong respectively;
determining whether another terminal device belonging to the first group is coupled to any one of the plurality of servers based on the group information and connection information indicating a connection relationship between the plurality of servers and at least one of the plurality of terminal devices;
when the other terminal device is coupled to any one of the plurality of servers, assigning a first server coupled to the other terminal device to the first terminal device; and
when the other terminal device is not coupled to any one of the plurality of servers, assigning a second server to the first terminal device, the second server being selected based on load information indicating respective loads of the plurality of servers.

2. The method according to claim 1, further comprising:
transmitting information of the first server or the second server to the first terminal device as a response to the request.

3. The method according to claim 2, wherein the first terminal device gets connected to the first server or the second server based on the information of the first server or the second server, received from the computer.

4. The method according to claim 1, wherein
the plurality of terminal devices include a plurality of supportee terminal devices used by users who remotely receive operation support and a plurality of supporter terminal devices used by other users who remotely perform the operation support, and
each of the groups includes at least one of the supportee terminal devices and at least one of the supporter terminal devices.

5. The method according to claim 4, wherein the first terminal device is included in the plurality of supportee terminal devices.

6. The method according to claim 5, wherein the first terminal device is configured to:
get coupled to the first server or the second server based on the information of the first server or the second server, transmitted from the computer, and
communicate with a supporter terminal device included in the first group, from among the plurality of supporter terminal devices, via the first server or the second server.

7. The method according to claim 1, further comprising:
after receiving the request, requesting connection states to the plurality of servers, the connection states indicating terminal devices coupled to the plurality of respective server;
receiving the connection states from the plurality of respective servers; and
generating the connection information based on the connection states.

8. The method according to claim 1, further comprising:
after receiving the request, requesting, to the plurality of servers, the load information of the plurality of respective servers; and
receiving the load information from the plurality of respective servers.

9. The method according to claim 1, wherein the information of the first server or the second server is identification information of the first server or the second server.

10. A method executed by a computer, the method comprising:
receiving identification information of a terminal device of a connection request source;
determining whether another terminal device included in a same terminal group as the terminal device is coupled to any one of information processing devices by referring to first association information, and second association information, the first association information associating identification information of a plurality of terminal devices included in a terminal group with the terminal group, and second association information associating identification information of terminal devices coupled to an information processing device with the information processing device;
when the other terminal device is not coupled to any one of the information processing devices, first transmitting first identification information of a first information processing device selected from a plurality of information processing devices, to the terminal device of the connection request source, based on load information of the plurality of information processing devices being connection candidates; and
when the other terminal device is coupled to any one of the information processing devices, second transmitting second identification information of a second information processing devices coupled to the other terminal device, to the terminal device of the connection request source.

11. The method according to claim 10, wherein the first transmitting transmits the first identification information of the first information processing device selected from the plurality of information processing devices based on a number of the other terminal devices, to the terminal device of the connection request source.

12. The method according to claim 10, wherein the load information is information regarding data traffic between the other terminal group and the information processing device and a number of coupled terminal devices when a terminal device included in the other terminal group is coupled to the information processing device.

13. The method according to claim 10, wherein the first transmitting transmits the first identification information of the first information processing device selected from the plurality of information processing devices based on a number of terminal groups including the terminal device of the connection request source, to the terminal device of the connection request source.

14. A device which communicates with a plurality of terminal devices and a plurality of servers, the device comprising:
a memory; and
a processor coupled to the memory and configured to:
receive a request for assignment of a server, among the plurality of servers, from a first terminal device among the plurality of terminal devices,
identify a first group to which the first terminal device belongs based on group information managing groups to which the plurality of terminal devices belong respectively,
determine whether another terminal device belonging to the first group is coupled to any one of the plurality of servers based on the group information and connection information indicating a connection relationship between the plurality of servers and at least one of the plurality of terminal devices,
when the other terminal device is coupled to any one of the plurality of servers, assign a first server coupled to the other terminal device to the first terminal device, and
when the other terminal device is not coupled to any one of the plurality of servers, assign a second server to the first terminal device, the second server being selected based on load information indicating respective loads of the plurality of servers.

15. The device according to claim 14, wherein the processor is configured to transmit information of the first server or the second server to the first terminal device as a response to the request.

16. The device according to claim 15, wherein the first terminal device gets connected to the first server or the second server based on the information of the first server or the second server, received from the device.

17. The device according to claim 14, wherein
the plurality of terminal devices include a plurality of supportee terminal devices used by users who remotely receive operation support and a plurality of supporter terminal devices used by other users who remotely perform the operation support, and
each of the groups includes at least one of the supportee terminal devices and at least one of the supporter terminal devices.

18. The device according to claim 17, wherein the first terminal device is included in the plurality of supportee terminal devices.

19. The device according to claim 18, wherein the first terminal device is configured to:
get coupled to the first server or the second server based on the information of the first server or the second server, transmitted from the device, and
communicate with a supporter terminal device included in the first group, from among the plurality of supporter terminal devices, via the first server or the second server.

20. The device according to claim 14, wherein the processor is configured to:
after receiving the request, request connection states to the plurality of servers, the connection states indicating terminal devices coupled to the plurality of respective server,
receive the connection states from the plurality of respective servers, and
generate the connection information based on the connection states.
